(19) United States
(12) Patent Application Publication
(10) Pub. No.: US 2016/0366333 A1
(43) Pub. Date: Dec. 15, 2016

(54) TRAIL CAMERA WITH SET-UP PROGRAM

(71) Applicant: Bushnell, Inc., Overland Park, KS (US)

(72) Inventors: Darin Stephens, Independence, MO (US); Wei Cao, Overland Park, KS (US); Zacharias John Fleer, Peculiar, MO (US); Nicholas J. Wolfe, Olathe, KS (US)

(21) Appl. No.: 14/739,086

(22) Filed: Jun. 15, 2015

(51) Int. Cl. H04N 5/232

(52) U.S. Cl. CPC H04N 5/23222; H04N 5/23216

(57) ABSTRACT

A trail camera includes a camera for capturing images; a sensor for sensing an object in the vicinity of the trail camera; and a control system for triggering operation of the camera in response to the sensor so as to capture an image of the object when it is in the vicinity of the trail camera. The trail camera also includes memory that stores a set-up program that includes code to allow a user to select camera operating parameters for the trail camera and a memory card port that can write to and read from a removable memory card so that the set-up program can be transferred to and executed by an external computer.

### BACKGROUND

The present invention relates to trail cameras and improved systems and methods of operating and controlling the same.

Trail cameras are basically cameras with sensors that capture images of animals, humans, or other objects upon sensing movement, heat, light, sound, or other activities that indicate the presence of the objects. Such cameras are typically housed in weatherproof enclosures and are often mounted to trees, fence posts, and other outdoor supports for capturing outdoor images or mounted in and/or around homes or other buildings for capturing indoor/outdoor images.

Trail cameras must be set-up with certain operating parameters such as the current date and time, an image resolution, an image transmission frequency, etc. Conventional trail cameras include on-board user interfaces consisting of buttons, switches, and/or a touchscreen display that may be operated to enter or otherwise select these operating parameters. Unfortunately, such on-board user interfaces add to the cost and complexity of the trail cameras.

### SUMMARY

The present invention solves at least some of the above-described problems and provides a distinct advance in the art of trail cameras. More particularly, the present invention provides a trail camera that may be set-up without an on-board user interface.

An embodiment of the trail camera broadly comprises a camera for capturing images;

a sensor for sensing an object in the vicinity of the trail camera; a control system for triggering operation of the camera in response to the sensor so as to capture an image of the object when it is in the vicinity of the trail camera; and an optional wireless communications component for wirelessly transmitting captured images to a remote device.

The trail camera also comprises internal memory and a memory card port that can write to and read from a memory card placed in the port. The memory stores a Java applet or other computer program (referred to herein as “set-up program”) that assists a user in selecting camera operating parameters for the trail camera. The set-up program may be executed by an external computer as described below so that the user may use the external computer rather than an on-board user interface to enter the operating parameters.

To set-up the trail camera, a user first places a memory card in the memory card port of the trail camera. The control system of the trail camera then downloads at least a portion of the set-up program from the memory on the trail camera onto the memory card. The user then removes the memory card from the trail camera and couples it with the external computer. The external computer reads the memory card and executes the set-up program on the memory card. The set-up program then prompts the user to enter operating parameters for the trail camera on the external computer.

For example, once executed by the external computer, the set-up program may prompt the user to select a current time and date for the trail camera, an image resolution setting for the camera, an image delay frequency, and other trail camera operating parameters. Once entered or otherwise selected by the user, the set-up program stores these operating parameters on the memory card. The user then removes the memory card from the external computer and inserts it back in the memory card port of the trail camera. The control system on the trail camera then reads the entered operating parameters from the memory card and stores them in the trail camera memory. The control system then controls operation of the trail camera in accordance with the stored operating parameters.

The present invention provides numerous advantages. For example, the set-up program allows the trail camera to be quickly and conveniently set-up with the aid of an external computer. This simplifies the set-up procedures in the field and eliminates the need for a dedicated user interface on the trail camera. Moreover, the user doesn't have to download the set-up program from a website or other source because the set-up program is already loaded in the memory of the trail camera and transferred to the external computer via the memory card port and memory card.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an elevational view of a trail camera constructed in accordance with embodiments of the present invention.

FIG. 2 is a block diagram depicting several components of an embodiment of the trail camera of FIG. 1.

FIG. 3 shows the trail camera with its front cover removed along with an external computer such as a laptop computer.

FIG. 4 shows transfer of the memory card between the trail camera and the laptop computer.

FIG. 5 shows transfer of the memory card back to the trail camera.

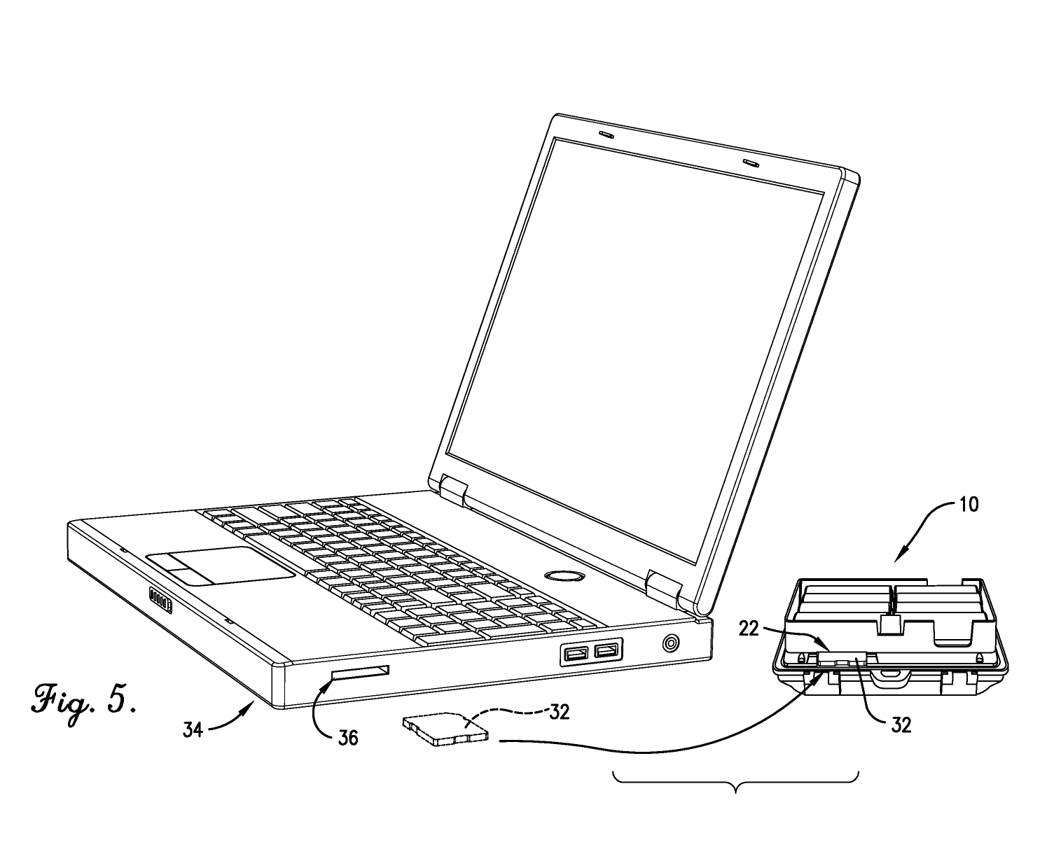

FIG. 6 shows a screen display that may be presented to a user via the external computer while setting up the trail camera.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

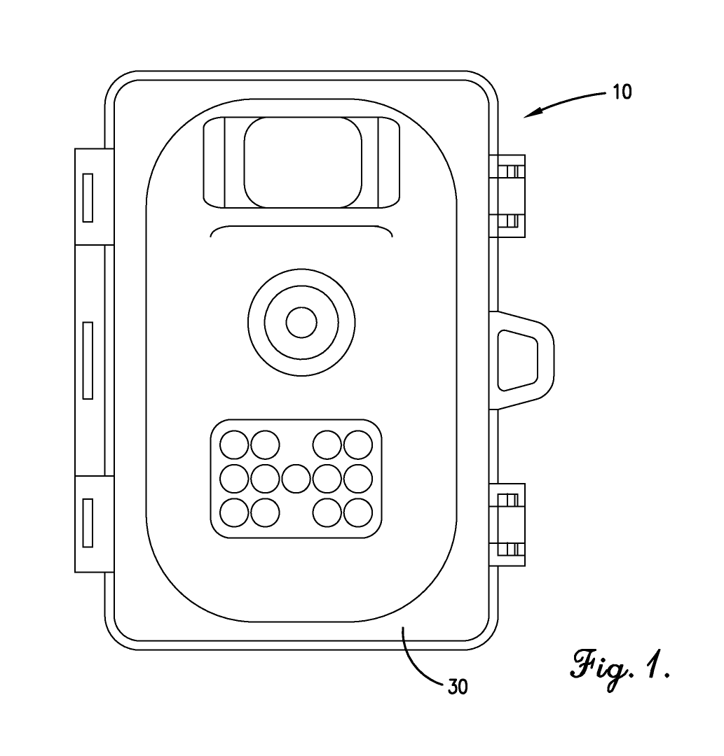

Turning now to the drawing figures, and initially FIG. 1, a trail camera 10 constructed in accordance with various embodiments of the invention is depicted. The trail camera 10 may be mounted to a tree, post, building, wall, or anywhere else and is operable to capture images of animals, people, or any other objects that trigger its sensors as described below.

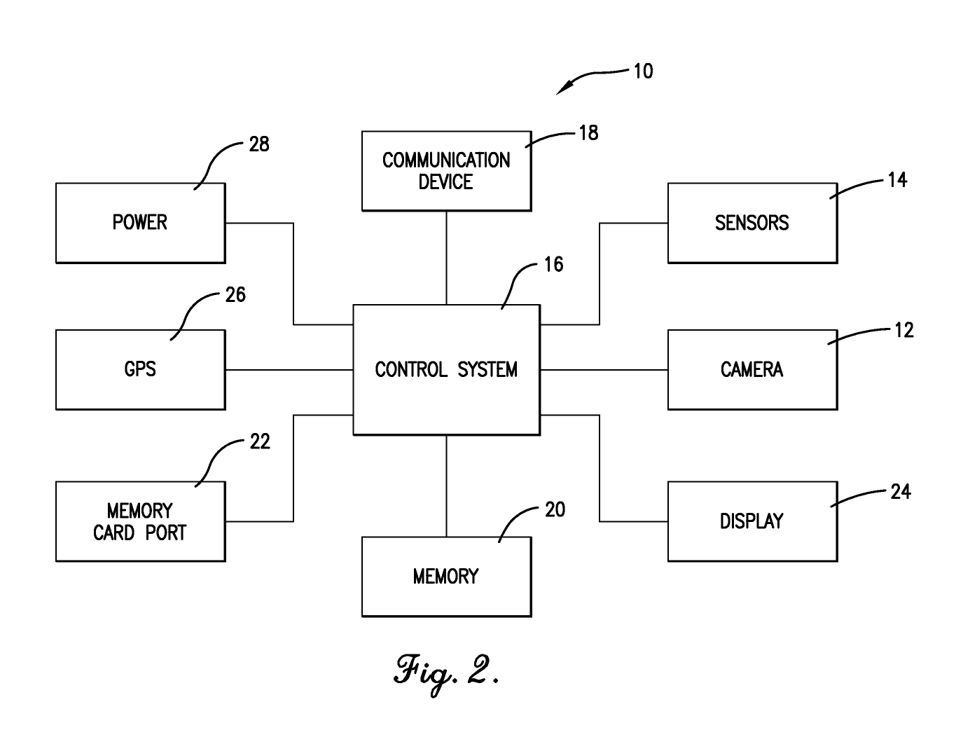

Certain major components of an embodiment of the trail camera 10 are shown in FIG. 2 and broadly comprise a camera 12 for capturing images; one or more sensors 14 for sensing objects in the vicinity of the trail camera; a control system 16 for triggering operation of the camera 12 in response to the sensors 14 so as to capture an image of an object when it is in the vicinity of the trail camera; and a possible wireless communications component 18 for wirelessly transmitting captured images to a remote device.

Embodiments of the trail camera 10 may also comprise memory 20 and a memory card port 22 that can write to and read from a removable memory card 32. The memory 20 stores a Java applet or other computer program (“set-up program”) that includes code to allow a user to select camera operating parameters for the trail camera. As described below, the set-up program may be executed by an external computer 34 so that the user may set-up the trail camera with the external computer.

Embodiments of the trail camera 10 may also comprise a display 24 and a GPS receiver 26 or other location determining device. These and other components may be powered by a power source 28 and enclosed in a weatherproof enclosure 30. The trail camera 10 may also include other components, circuitry, and controls that are not as important to the present invention and therefore not described in detail herein.

The camera 12 may employ any known image capturing technology. An embodiment of the camera may include a CCD/CMOS image sensor that is operable to capture and record still images or video images. The camera 12 may include various conventional camera elements such as a lens and a flash. The lens is conventional and can be adjusted to facilitate aiming and focusing of the camera. The flash may include any known flash elements such as conventional light emitting diodes (LED's), infrared LED's, Xenon strobes, and/or incandescent bulbs. The flash may enable night vision capabilities of the camera.

The sensors 14 are operable to detect the presence of an animal, person, or other object in the vicinity of the trail camera 10 and trigger the camera 12 to capture an image of the object. The sensors 14 may employ any technology operable to detect heat, light, motion, sound, vibration, the passage of time, etc., or any combination thereof to trigger the camera 12. For example, the sensors may include a passive infrared motion detector operable to detect movement of an animal or human and/or a heat detector operable to detect body heat from an animal or human.

The control system 16 controls the camera 12 and the other components of the trail camera 10 and may comprise various computing elements, such as integrated circuits, microcontrollers, microprocessors, programmable logic devices, memory, etc, alone or in combination, to perform the operations described herein. The control system 16 may also include, or be coupled with, other components such as switches, sensors, etc. and may include circuitry or programs to determine when to capture and record an image with the camera 12 after triggering by the sensors 14.

The optional communications device 18 transmits images captured by the camera 12 to remote devices such as remote computers, mobile phones, etc. The communications device 18 may also transmit data to and receive data from remote devices. In one embodiment, the communications device 18 is a wireless cellular radio transceiver operable to transmit and receive data via a wireless phone network such as those operated by AT&T, Sprint, and Verizon.

The memory 20 stores images captured by the camera 12. In accordance with an important aspect of the present invention, the memory also stores a Java applet or other programs, data, or information for setting up and operating the trail camera 10 as discussed in more detail below. The memory 20 may comprise any non-transitory digital storage medium such as RAM, ROM, flash memory, a hard disk, magnetic or optical storage mediums, or other conventional digital mediums, and combinations thereof.

The memory card port 22 may be any input/output device that can write to and read from a removable memory card. The memory card port 22 may be compatible with SD cards, MMC cards, compact flash memory cards, mini/micro SD cards, memory sticks, XD cards, or any other type of memory device.

The display 24 is optional and is operable to display messages, instructions, and other information and may employ any known display technology. In one embodiment, the display is a liquid crystal display (LCD). The display may incorporate touch screen technology and/or may be accompanied with conventional buttons, switches, and other user interface elements. In one embodiment of the invention, no display or other user interface is provided on the trail camera to reduce the cost and complexity of the trail camera as described below.

The GPS receiver 26 is also optional. The GPS receive or other location-determining device receives satellite signals from a global navigation satellite system and determines locations of the trail camera as a function of these signals. The control system 16 may monitor the calculated locations and send an alert via the communications device 18 if the trail camera is moved from its installation location. The GPS receiver and control system 16 may also trigger the camera 12 to capture one or more images if the trail camera is moved after it is installed in an attempt to capture images of the thief or other person moving the camera. These images may be transmitted from the trail camera via the communications device 18 in the same manner as other captured images.

The power source 28 provides power to the other components of the trail camera 10 and may comprise any source of electricity such as batteries, a battery pack, or a receptacle for receiving power from an external source, such as a power line.

The enclosure 30 houses the above-described components and other components of the trail camera 10. The enclosure may include hinges, gaskets, seals, and other conventional features and may further include hangars, brackets, etc. for facilitating the attachment of the trail camera to trees, posts, walls, etc.

Aspects of the invention may be implemented in part by a Java applet or other computer program or programs stored in and/or accessed by components of the trail camera. The Java applet or other program is used to set-up or initialize the trail camera as described in more detail below and may be referred to herein as “set-up program”. The set-up program and other computer programs of the present invention are stored in the memory 20 or other non-transitory computer-readable medium residing on or accessible by the trail camera 10 and may be partially downloaded to a removable memory card via the memory card port 22 as discussed in more detail below. The set-up program comprises ordered listings of executable instructions for implementing logical functions in these devices.

The set-up program and other computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any non-transitory means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

Use of the set-up program will now be discussed in more detail. As previously discussed, the set-up program is stored in the memory 20 or other memory of the trail camera and may be used to set-up the trail camera with the external computer 34 in lieu of using an on-board user interface on the trail camera to do so.

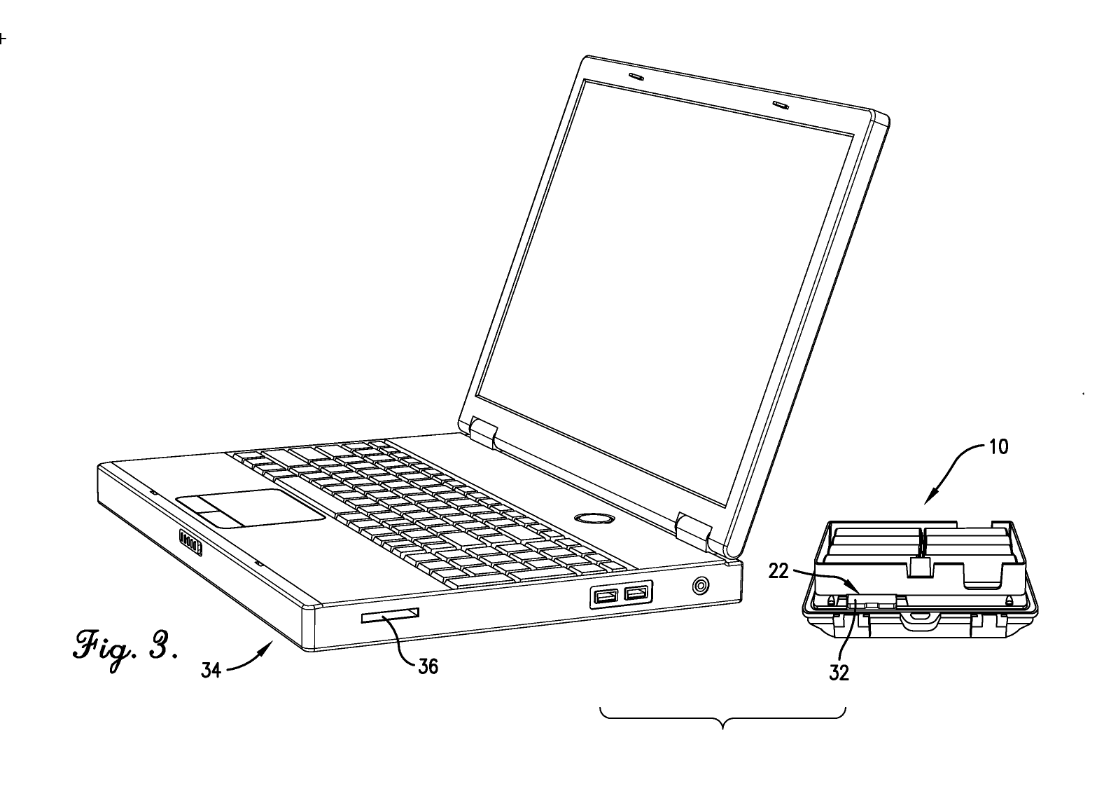

To set-up the trail camera 10, a user places a memory card 32 in the memory cart port 22 of the trail camera 10 as depicted in FIG. 3. The control system 16 then downloads at least a portion of the set-up program from the memory 20 on the trail camera onto the memory card 32. The control system 16 may first read the memory card 32 to ensure it is blank before downloading the program to the card or may automatically download the program to the memory card the first time it is inserted in the memory card port 22.

In one embodiment, the user is prompted to insert the memory card 32 into the memory card port 22 and to then switch an on/off button on the trail camera to the on position to prompt the control system to save the set-up program to the memory card 32. The user is then prompted to turn the on/off button to the off position.

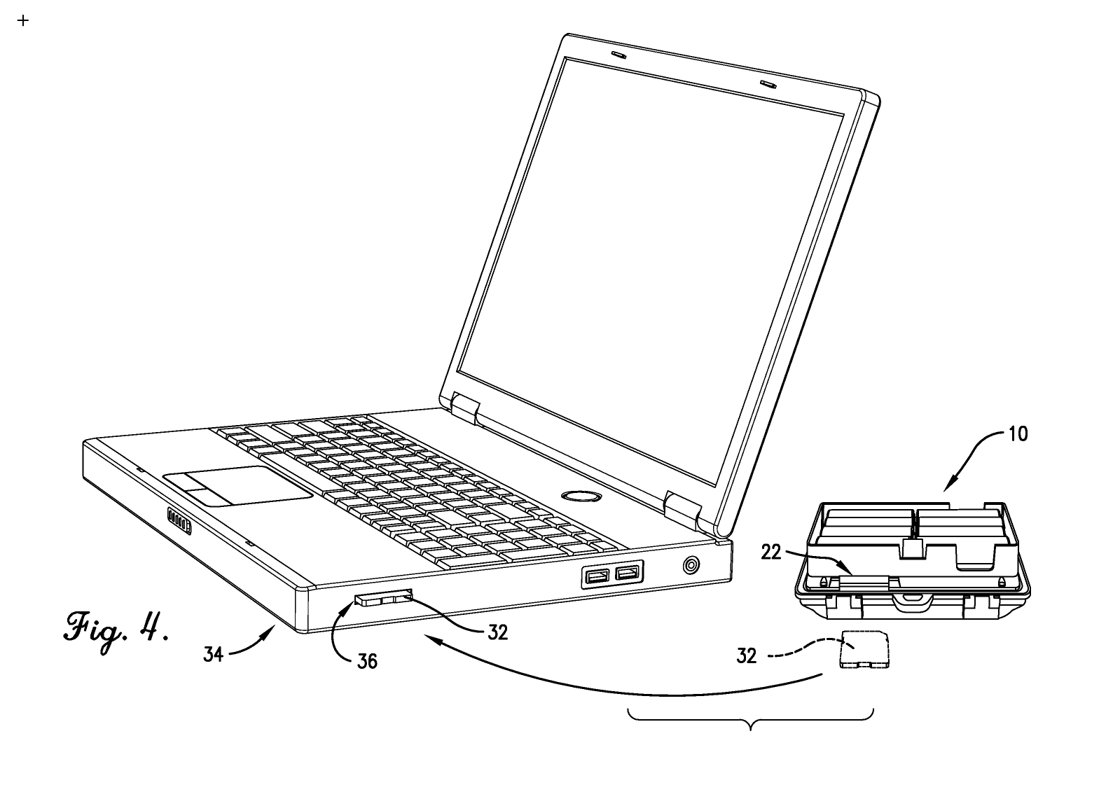

The user then removes the memory card 32 from the trail camera and inserts it in a memory card port 36 of the external computer 34 as depicted in FIG. 4. The external computer 34 reads the memory card 32 and executes the set-up program on the card. The set-up program then prompts the user to enter operating parameters for the trail camera via the external computer. The set-up program then stores these operating parameters on the memory card 32.

The user then removes the memory card 32 from the external computer 34 and inserts it back in the memory card port 22 of the trail camera 10. The control system 16 on the trail camera 10 then reads the operating parameters stored on the memory card 32 and stores them in the trail camera memory 20. The control system 16 then controls operation of the trail camera in accordance with the stored operating parameters.

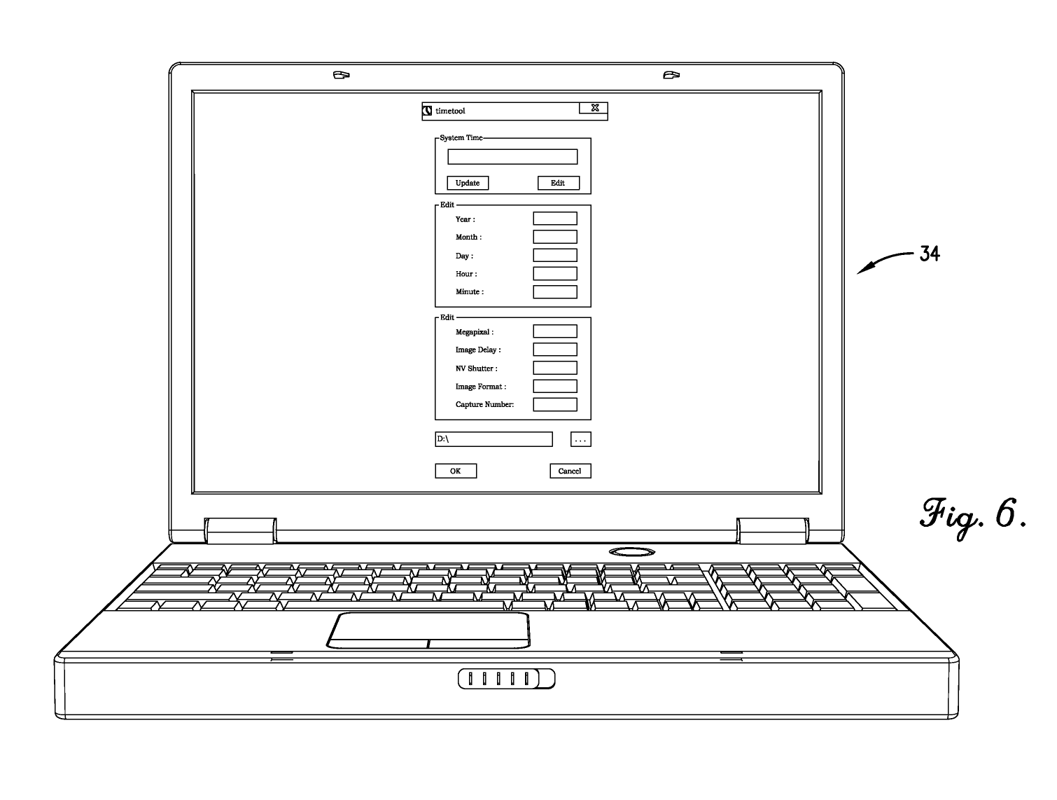

FIG. 6 illustrates a screen display that may be presented on the external computer 34 while executing the set-up program. The screen shown in FIG. 6 prompts the user to enter a number of settings including the current time and date so that this date and time information can be used to set the date and time in the trail camera. In one embodiment, the set-up program automatically reads the date and time from the clock of the external computer 34 so that the user doesn't have to enter such information.

The screen also permits the user to select an image resolution, an image format, an image transmit frequency, and a captures per trigger setting (the number of images to capture each time the camera is triggered), and other operating parameters.

The present invention provides numerous advantages. For example, the Java applet or other set-up program allows the trail camera 10 to be quickly and conveniently set up with the aid of an external computer 34. This simplifies the set-up procedures and eliminates the need for an on-board user interface on the trail camera. Moreover, by storing the Java applet on the trail camera and transferring it to the external computer via the memory card port and removable memory card, the user doesn't have to download a set-up program from a website.

Although the invention has been described with reference to the preferred embodiment illustrated in the attached drawing figures, it is noted that equivalents may be employed and substitutions made herein without departing from the scope of the invention as recited in the claims. For example, although the technology of the present invention is particularly useful for trail cameras, it may also be employed in other camera systems such as surveillance cameras.

Having thus described the preferred embodiment of the invention, what is claimed as new and desired to be protected by Letters Patent includes the following:

1. A trail camera comprising:
a camera for capturing images;
a sensor for sensing an object in the vicinity of the trail camera;
a control system for triggering operation of the camera in response to the sensor so as to capture an image of the object when it is in the vicinity of the trail camera;
memory for storing a set-up program that may be executed by an external computer for setting operating parameters of the trail camera; and
a memory card port;
when control system downloads at least a portion of the set-up program from the memory onto a memory card that is inserted in the memory card port and subsequently reads the memory card when is it inserted back in the memory card port to read operating parameters that have been stored on the memory card by the external computer.

2. The trail camera as set forth in claim 1, wherein the camera operating parameters are selected from the group consisting of a current time, a current date, a photo capturing delay, a photo capturing frequency, and an image resolution.

3. The trail camera as set forth in claim 1, wherein the set-up program is a Java applet.

4. The trail camera as set forth in claim 1, wherein the control system automatically downloads the set-up program onto the memory card when the memory card is inserted in the memory card port for the first time.

5. The trail camera as set forth in claim 1, wherein the control system automatically reads the operating parameters from the memory card when the memory card is inserted in the memory card port after it has been coupled with the external computer for entry of the operating parameters.

6. The trail camera as set forth in claim 1, wherein the set-up program prompts the user to enter the operating parameters when the memory card is coupled with the external computer and then prompts the user to insert the memory card back in the memory card port of the trail camera so the control system may read the operating parameters from the memory card.

7. The trail camera as set forth in claim 1, further comprising a wireless communications component for wirelessly transmitting the image to a remote device.

8. A trail camera comprising:
a camera for capturing images;
a motion sensor for sensing motion of an object in the vicinity of the trail camera;
a control system for triggering operation of the camera in response to the motion sensor so as to capture an image of the object when it is in the vicinity of the trail camera;
non-transitory computer readable memory that stores a set-up program that includes code to allow a user to select camera operating parameters and that may be executed by an external computer;
a wireless communications component for wirelessly transmitting the image to a remote device; and
a memory card port;
wherein the control system downloads at least a portion of the set-up program from the memory onto a memory card that is inserted in the memory card port so that the memory card may be coupled with the external computer for entering the camera operating parameters, and wherein the control system subsequently reads the memory card when is it inserted back in the memory card port so as to read and store the operating parameters and to control operation of the trail camera in accordance with the operating parameters.

9. The trail camera as set forth in claim 8, wherein the camera operating parameters are selected from the group consisting of a current time, a current date, a photo capturing delay, a photo capturing frequency, and an image resolution.

10. The trail camera as set forth in claim 8, wherein the set-up program is a Java applet.

11. The trail camera as set forth in claim 8, wherein the control system automatically downloads the set-up program onto the memory card when the memory card is inserted in the memory card port for the first time.

12. The trail camera as set forth in claim 8, wherein the control system automatically reads the operating parameters from the memory card when the memory card is inserted in the memory card port after it has been coupled with the external computer for entry of the operating parameters.

13. The trail camera as set forth in claim 8, wherein the set-up program prompts the user to enter the operating parameters when the memory card is coupled with the external computer and then prompts the user to insert the memory card back in the memory card port of the trail camera so the control system may read the operating parameters from the memory card.

14. A trail camera comprising:
a camera for capturing images;
a motion sensor for sensing motion of an object in the vicinity of the trail camera;
a control system for triggering operation of the camera in response to the motion sensor so as to capture an image of the object when it is in the vicinity of the trail camera, the control system having no user interface buttons, switches, or touchscreen displays so that operating parameter for the trail camera cannot be set-up directly at the trail camera;
a wireless communications component for wirelessly transmitting the image to a remote device; and
a memory card port;
wherein the control system downloads at least a portion of a set-up program onto a memory card that is inserted in the memory card port, the set-up program including code that allows a user to select camera operating parameters from an external computer when the memory card is coupled with the external computer; and wherein the control system further reads the memory card when is it inserted back in the memory card port so as to read and store the operating parameters and to control operation of the trail camera in accordance with the operating parameters.

15. The trail camera as set forth in claim 14, wherein the camera operating parameters are selected from the group consisting of a current time, a current date, a photo capturing delay, a photo capturing frequency, and an image resolution.

16. The trail camera as set forth in claim 14, wherein the set-up program is a Java applet.

17. The trail camera as set forth in claim 14, wherein the control system automatically downloads the set-up program onto the memory card when the memory card is inserted in the memory card port for the first time.

18. The trail camera as set forth in claim 14, wherein the control system automatically reads the operating parameters from the memory card when the memory card is inserted in the memory card port after it has been coupled with the external computer for entry of the operating parameters.

19. The trail camera as set forth in claim 14, wherein the set-up program prompts the user to enter the operating parameters when the memory card is coupled with the external computer and then prompts the user to insert the memory card back in the memory card port of the trail camera so the control system may read the operating parameters from the memory card.

20. The trail camera as set forth in claim 14, wherein the set-up program may be used to update the operating parameters after they have been read by the control system.

21. A method of setting-up a trail camera comprising:
placing a memory card in a memory card port of the trail camera;
downloading a set-up program from memory in the trail camera to the memory card via the memory card port;
removing the memory card from the memory card port of the trail camera;
inserting the memory card in a memory card slot of an external computer;
executing the set-up program on the memory card with the external computer;
entering operating parameters on the external computer and saving data representative of the operating parameters on the memory card;
removing the memory card from the memory card port of the external computer;
placing the memory card back into the memory card port of the trail camera; and
uploading the data representative of the operating parameters from the memory card to the memory of the trail camera.
